(19) United States
(12) Patent Application Publication
(10) Pub. No.: US 2005/0073109 A1
(43) Pub. Date: Apr. 7, 2005

(54) Radial Shaft Seal

(75) Inventor: Markus Schwerdtfeger, Mannheim (DE)

Correspondence Address: GUDRUN E. HUCKETT DRAUDT, LONSSTR. 53, WUPPERTAL, 42289, DE

(73) Assignee: KACO GMBH + CO. KG, Heilbronn (DE)

(21) Appl. No.: 10/711,815

(22) Filed: Oct. 7, 2004

(30) Foreign Application Priority Data
Oct. 7, 2003 (DE) 10346419.0

(51) Int. Cl. F16J 15/32

(52) U.S. Cl. 277/549

(57) ABSTRACT

A radial shaft seal has a sealing ring having a support housing and a shell of elastomer material surrounding at least partially the support housing. The sealing ring has a sealing lip with a sealing edge or sealing surface that rests seal-tightly against a rotary machine part. The sealing lip has a first conical surface at a side facing the medium to be sealed and a second conical surface at a side facing the surrounding atmosphere. The first and second conical surfaces adjoin the sealing lip. Between the machine part and the first conical surface a first contact surface angle is formed; between the rotary machine part and the second conical surface a second contact surface angle is formed. The first contact surface angle is adjusted to be between 0 and 30 degrees and the second contact surface angle is adjusted to be between 30 up to 70 degrees.

### BACKGROUND OF THE INVENTION

The invention relates to a radial shaft seal comprising a support housing that is surrounded at least partially by a shell of elastomer material and further comprising a sealing lip that seal-tightly rests with a sealing edge or sealing surface against a rotary machine part, preferably a shaft, wherein, at the side of the radial shaft seal facing the medium and at the side of the radial shaft seal facing the atmosphere, a contact surface angle is formed between the machine part and a conical surface on either side of the sealing edge or sealing surface, respectively.

Radial shaft seals of elastomer material for sealing pressure-loaded devices are known. Such sealing rings or seals generally can be used only for relatively low overpressure and relatively low circumferential speed. Their use at higher pressures and higher circumferential speeds or rpm (revolutions per minute) cause in a very short period of time excessive temperatures at the dynamic sealing edge or sealing surface as a result of lack of lubrication and the presence of pressure-dependent surface pressure (radial force). This causes deposition of the fluid to be sealed on the dynamic sealing edge or sealing surface as well as deposition of reaction products of the fluid to be sealed on the dynamic sealing edge or sealing surface; moreover, this can accelerate aging of the elastomer material of the sealing edge or sealing surface. Also, the running surface of the shaft as well as the dynamic sealing edge or sealing surface are subject to abrasive wear. Such damages cause failure of the seal or sealing ring and lead to impermissibly high leakage at the sealing location.

### SUMMARY OF THE INVENTION

It is an object of the present invention to configure a radial shaft seal of the aforementioned kind such that it ensures a reliable sealing action even at high pressures and high circumferential speeds.

In accordance with the present invention, this is achieved in that the contact surface angle of the sealing edge or sealing surface at the side facing the medium is between approximately 0 degrees and approximately 30 degrees and the contact surface angle of the sealing edge or sealing surface at the side facing the atmosphere is between approximately 30 degrees up to approximately 70 degrees.

As a result of the configuration according to the invention, the fluid to be sealed is conveyed in the direction to the side facing the atmosphere and thus to the sealing edge or sealing surface so that a sufficient lubrication and cooling action is achieved. High temperatures at the dynamic sealing edge or sealing surface are reliably prevented in this way. With the configuration of the contact surface angle at the side facing the medium and the side facing the atmosphere in accordance with the present invention, the lubrication situation below the sealing edge can be adjusted as an optimal compromise between service life and leakage. The radial shaft seal can be manufactured inexpensively and requires only a minimal mounting space. As a result of the configuration according to the invention deposition of the medium to be sealed as well as of reaction products of the medium to be sealed on the dynamic sealing edge or sealing surface is reliably prevented. An accelerated aging of the material of the sealing lip at the dynamic sealing edge or sealing surface is prevented. An abrasive wear of the running surface of the machine parts and of the sealing edge or sealing surfaces is prevented. The seal according to the invention has therefore a long service life and can be used excellently at high pressures and/or high circumferential speeds of the machine part.

### BRIEF DESCRIPTION OF THE DRAWING

FIG. 1 shows an embodiment of the radial shaft seal according to the invention in axial section, wherein only the upper half of the radial shaft seal is shown as it is positioned on the shaft.

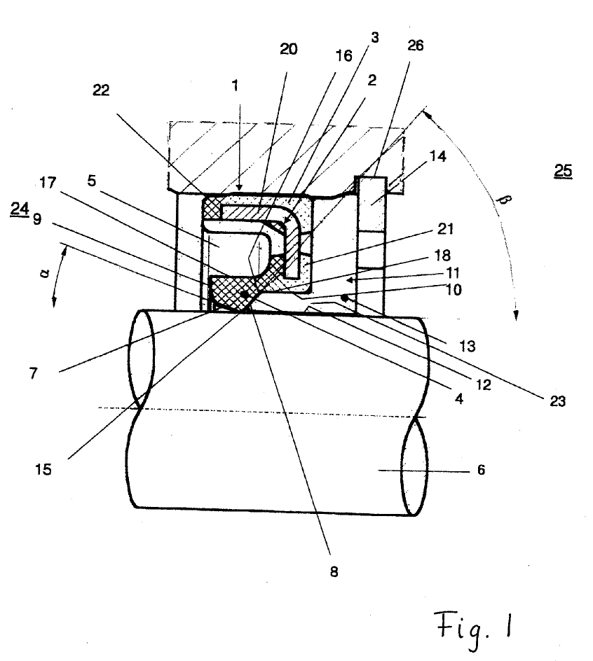

### DESCRIPTION OF THE PREFERRED EMBODIMENTS

The only drawing shows in axial section one half of a radial shaft seal that is provided for sealing a pressure-loaded device. The sealing ring 1 of the radial shaft seal has a cup-shaped support housing 2, as is known in the art, that is surrounded by a shell 3 of elastomer material. The support housing 2 can be made of a metallic material or a hard plastic material and comprises a cylindrical jacket 20 adjoined by a radially extending bottom 21. The jacket 20 and the bottom 21 are covered at their radial outer side by the shell 3 that extends across the free end face 22 of the jacket 20. The shell 3 engages the edge of a central opening 23 in the housing bottom 21 through which the shaft 6 to be sealed projects.

The sealing ring 1 rests with a sealing edge 15 of a sealing lip 4 on the shaft 6. The sealing lip 4 is advantageously a monolithic part of the shell 3. Of course, it is also possible to produce the sealing lip 4, with regard to its sealing function, of a different material than the shell 3. The sealing lip 4 extends from the housing bottom 21 in the direction toward the medium side 24 of the seal.

The sealing ring 1 is pressed into a mounting space or receiving space 5 of the device. The part of the shell 3 covering the jacket 20 of the housing 2 rests sealingly on the inner wall of the mounting space 5 and forms a static seal. The sealing edge 15 of the sealing lip 4 is positioned seal-tightly on the shaft 6. The sealing lip 4 has a substantially triangular cross-section. The sealing edge 15 is generated by the intersection line of two slanted conical surfaces 7 and 8. The conical surface 7 faces the medium to be sealed and the conical surface 8 faces the atmosphere side 25 of the seal.

The conical surface 7 passes into a radially extending annular end face 9 facing the medium while the conical surface 8 passes at a distance from the shaft 6 at an obtuse angle into an annular surface 10 that extends substantially coaxially relative to the shaft 6.

The radial shaft seal in the illustrated embodiment has a support ring 11 that engages substantially positively the sealing ring 1 at the side of radial shaft seal that is facing the surrounding atmosphere. The support ring 11 has an L-shaped cross-section with a ring part 12 that extends coaxially to the shaft 6 and a ring part 13 that extends radially and has approximately twice the thickness of the ring part 12. The support ring 11 rests with the ring part 13 against the securing ring 14 positioned adjacent to the support ring 11 at the side (25) of the radial shaft seal facing the atmosphere. The securing ring 14 is inserted into an annular groove 26 in the inner wall of the mounting space 5. The ring part 12 surrounds the shaft 6 with minimal radial play so that the shaft 6 can rotate without interference.

The ring part 13 has substantially the same outer diameter as the shell 3. The ring part 12 has an end face 16 that extends at a slant to the shaft 6. The end face 16 is a conical support surface positioned on a cone surface of an imaginary cone that tapers in the direction toward the side 24 of the radial shaft seal facing the medium. The conical surface 8 of the sealing lip 4 rests areally on the conical end face (conical support surface) 16. The annular surface 10 of the sealing lip 4 rests against the outer side 18 of the ring part 12 of the support ring 11. The radial ring part 13 rests against the part of the shell 3 covering the housing bottom 21 and against the securing ring 14.

In order to be able to employ the sealing ring 1 at higher pressures and higher rpm, a satisfactory lubrication and cooling action of the sealing edge 15 of the sealing lip 6 must be ensured in order to provide an optimal sealing action. This is achieved in that a contact surface angle α between the shaft 6 and the conical surface 7 facing the medium in the range of between approximately 0 degrees and approximately 30 degrees is adjusted when the sealing ring 1 is in the mounted position. In this angle range, the medium is conveyed in the direction toward the atmosphere side 25 so that the sealing edge 15 is sufficiently lubricated and cooled at all times.

In the mounted state of the sealing ring 1, the contact surface angle β between the shaft 6 and the conical surface 8 facing the atmosphere is in the range of approximately 30 degrees and approximately 70 degrees. In the illustrated embodiment, this angle β is approximately 50 degrees.

Depending on the application and/or configuration of the sealing ring 1, different angles α and β can be provided within the mentioned range.

The support ring 11 and its end face in the form of conical surface 16 are shaped such that the configuration of the contact surface angle β at the side facing the atmosphere is enhanced. By adjusting the aforementioned sealing surface angles α and β, it is ensured that during operation of the sealing ring 1 below the sealing edge 15 or sealing surface sufficient medium for cooling and lubrication is present. The sealing ring is thus property lubricated and cooled even at high pressures and high rpm so that a safe sealing action is ensured.

The support ring 11 can be omitted, in particular, when the sealing lip 4 is comprised of an appropriate stiff material.

The conveying action of the dynamic sealing lip 4 can be improved additionally by providing conveying means or conveying structures, for example, ribs, grooves, wave-shaped profiles or configurations or the like on the conical surface 7 facing the medium and/or the conical surface 8 facing the atmosphere. The conveying structures can extend in the circumferential direction of the sealing lip. It is also possible to employ oppositely oriented conveying structures on the conical surfaces 7, 8. A further improvement of the lubrication situation and of the cooling action can be achieved in that the sealing edge 15 or the conical surfaces 7, 8 in the circumferential direction are undulated or waved-shaped. The undulation can be provided during shaping of the elastomer sealing lip 4 or by an appropriate shaping of the support ring 11. With such a conveying structure, the lubrication situation below the sealing edge 15 or the sealing surface and thus the service life of the sealing ring 1 and its leakage can be adjusted optimally.

In the illustrated sealing ring 1 the sealing lip 4 is not forced by a spring force against the shaft 6. The sealing ring 1 should therefore be used only in such devices where the medium to be sealed is permanently pressurized. The medium loads the exterior side 17 of the sealing lip 4 so that it is pressed against the shaft 6.

When the medium is not pressurized at all times, the sealing lip 4 should be loaded by an annular spring (not illustrated) in the direction toward the shaft 6. The annular spring advantageously is positioned in a recess within the exterior side 17 of the sealing lip 4, advantageously approximately at the level of the sealing edge (sealing surface) 15.

The described radial shaft seal or sealing ring 1 can be produced inexpensively and can be mounted in a space-saving way.

While specific embodiments of the invention have been shown and described in detail to illustrate the inventive principles, it will be understood that the invention may be embodied otherwise without departing from such principles.

1. A radial shaft seal comprising:
a sealing ring comprising a support housing and a shell of elastomer material surrounding at least partially the support housing;
wherein the sealing ring comprises a sealing lip having a sealing edge or sealing surface configured to rest seal-tightly against a rotary machine part;
wherein the sealing lip has a first conical surface at a first side facing a medium to be sealed and a second conical surface at a second side facing a surrounding atmosphere, wherein the first and second conical surfaces adjoin the sealing lip;
wherein between the rotary machine part and the first conical surface a first contact surface angle is formed and wherein between the rotary machine part and the second conical surface a second contact surface angle is formed;
wherein the first contact surface angle is adjusted to be between approximately 0 degrees and approximately 30 degrees and the second contact surface angle is adjusted to be between approximately 30 degrees up to approximately 70 degrees.

2. The radial shaft seal according to claim 1, wherein the sealing lip is a monolithic part of the shell.

3. The radial shaft seal according to claim 1, wherein the sealing lip and the shell are comprised of different materials, respectively.

4. The radial shaft seal according to claim 1, further comprising a support ring against which support ring the sealing ring rests, wherein the support ring is arranged on a side of the sealing ring facing the surrounding atmosphere.

5. The radial shaft seal according to claim 4, wherein the support ring has an L-shaped cross-section.

6. The radial shaft seal according to claim 4, wherein the support ring comprises an axial part resting against the sealing lip.

7. The radial shaft seal according to claim 6, wherein the axial part of the support ring has a conical support surface tapering in a direction toward the medium to be sealed.

8. The radial shaft seal according to claim 7, wherein the conical support surface has an angle matching the first contact surface angle.

9. The radial shaft seal according to claim 6, wherein the support ring comprises a radial part, wherein the support housing and the shell rest against the radial part of the support ring.

10. The radial shaft seal according to claim 9, wherein the radial part of the support ring extends essentially across an entire radial width of the sealing ring.

11. The radial shaft seal according to claim 1, wherein at least one of the first conical surface and the second conical surface has at least one conveying structure.

12. The radial shaft seal according to claim 11, wherein the at least one conveying structure is selected from the group consisting of grooves, wave-shaped profiles, and ribs.

13. The radial shaft seal according to claim 11, wherein the conveying structure on the second conical surface is oriented opposite to the conveying structure of the first conical surface.

14. The radial shaft seal according to claim 1, wherein the sealing lip is prestressed by a spring force in a direction toward the rotary machine part.

15. The radial shaft seal according to claim 1, wherein the at least one of the first conical surface and the second conical surface has a wave-shaped profile in a circumferential direction of the sealing ring.

16. The radial shaft seal according to claim 15, further comprising a support ring against which support ring the sealing ring rests, wherein the support ring is arranged on a side of the sealing ring facing the surrounding atmosphere, wherein the wave-shaped profile is generated by an appropriate shaping of the support ring.
